(19) United States
(12) Patent Application Publication
(10) Pub. No.: US 2003/0064884 A1
(43) Pub. Date: Apr. 3, 2003

(54) Recyclable and reusable ruthenium catalyst for olefin metathesis

(76) Inventor: Qingwei Yao, DeKalb, IL (US)

Correspondence Address: Amy E. Rinaldo, Kohn & Associates, Suite 410, 30500 Northwestern Hwy., Farmington Hills, MI, 48334, US

(21) Appl. No.: 10/117,511

(22) Filed: Apr. 4, 2002

Related U.S. Application Data
(60) Provisional application No. 60/281,978, filed on Apr. 6, 2001.

(51) Int. Cl. B01J 31/00

(52) U.S. Cl. 502/159

(57) ABSTRACT

There is provided an immobilized ruthenium complex for use as a catalyst. Also provided is a method of forming a recyclable catalyst for olefin metathesis by attaching a ruthenium carbene to a polymeric support.

### CROSS REFERENCE TO RELATED APPLICATIONS

This application claims priority to U.S. Provisional Application Serial No. 60/281,978, filed Apr. 6, 2001, which is incorporated herein by reference.

### BACKGROUND OF THE INVENTION

1. Field of the Invention

Generally, the present invention relates to the synthesis of highly active ruthenium carbene metathesis catalysts. More specifically, the present invention relates to recyclable and reusable ruthenium catalysts.

2. Description of Related Art

To the synthetic organic or polymer chemist, simple methods for forming carbon-carbon bonds are extremely important and valuable tools. One method of C-C bond formation that has proved particularly useful is transition-metal catalyzed olefin metathesis. The past two decades of intensive research effort has recently culminated in the discovery of well-defined ruthenium carbene complex catalysts that are highly metathesis active and stable in the presence of a variety of functional groups. Ruthenium carbene complexes have been described in U.S. Pat. Nos. 5,312,940 and 5,342,909, all of which are incorporated herein by reference. The ruthenium carbene complexes disclosed in these patents all possess metal centers that are formally in the +2 oxidation state, have an electron count of 16, and are penta-coordinated.

Specific vinyl alkylidene ruthenium complexes in which the neutral electron donor ligands L and L¹ are triphenyl phosphines or diphenylmethyl phosphines. The catalysts are useful in catalyzing the ring opening metathesis polymerization (“ROMP”) of strained olefins.

New materials and methods of synthesis are emerging as significant areas of research and manufacturing. They have applications in the fields of biotechnology, medicine, pharmaceuticals, medical devices, sensors, and optical materials. The ring-opening metathesis polymerization (ROMP) method has emerged as a powerful synthetic method for the creation of such useful materials. Many examples in which ROMP has been used to generate functionalized materials have focused on the incorporation of pendant functionality into the monomers, thereby forming a multivalent array. As used herein, a multivalent array refers to a polymer (random or blocks of varying lengths, including shorter oligomers) having pendant functional groups that impart various properties to the polymer. Such multivalent arrays are also often referred to as multivalent ligands, multivalent displays, multidentate arrays, multidentate ligands, or multidentate displays.

Such multivalent arrays are particularly useful in the medical and biotechnology areas. For example, the binding of cell surface receptors to particular epitopes of multivalent arrays can trigger a wide variety of biological responses. Such multivalent binding events have unique consequences that are dramatically different than those elicited by monovalent interactions. For instance, signaling through the epidermal growth factor is promoted by the binding of divalent ligands, which promote dimerization of the transmembrane receptor, yet monovalent ligands also bind the receptor but produce no signal. In addition, multivalent arrays have been shown to induce the release of a cell surface protein, suggesting a new mechanism for controlling protein display. In protein-carbohydrate recognition processes, multivalent saccharide-substituted arrays can exhibit increased avidity, specificity, and unique inhibitory potencies under dynamic conditions of shear flow. Thus, the ability to synthesize defined, multivalent arrays of biologically relevant binding epitopes provides a means for exploring and manipulating physiologically significant processes.

One method of synthesis in which this can be done is through the use of ROMP technology. ROMP has been used to generate defined, biologically active polymers (Gibson et al., Chem. Commun., 1095-1096 (1997); Biagini et al., Chem. Commun., 1097-1098 (1997); Biagini et al., Polymer, 39, 1007-1014 (1998); and Kiessling et al., Topics in Organometallic Chemistry, 1, 199-231 (1998)) with potent and unique activities that range from inhibiting protein-carbohydrate recognition events to promoting the proteolytic release of cell surface proteins (Mortell et al., J. Am. Chem. Soc., 118, 2297-2298 (1996); Mortell et al., J. Am. Chem. Soc., 116, 12053-12054 (1994); Kanai et al., J. Am. Chem. Soc., 119, 9931-9932 (1997)); Kingsbury et al., J. Am. Chem. Soc., 121, 791-799 (1999); Schrock et al., J. Am. Chem. Soc., 112, 3875-3886 (1990); Gordon et al., Nature, 392, 30-31 (1998); and Sanders et al., J. Biol. Chem., 274, 5271-5278 (1999).

The assembly of multivalent materials by ROMP has several advantages over classical methods for generation of multivalent displays. Specifically, ROMP can be performed under living polymerization conditions and, if the rate of initiation is faster than that of propagation, varying the monomer to initiator ratio (M:l) can generate materials of defined length (Ivin, Olefin Metathesis and metathesis polymerization; Academic Press: San Diego, 1997). This approach has been successfully applied with the Grubb's ruthenium metal carbene catalyst ([(Cy)₃ P]₂ Cl₂ Ru═CHPh) to generate materials with narrow polydispersities, indicating that the resulting substances are fairly homogeneous (Dias et al., J. Am. Chem. Soc., 119, 3887-3897 (1997); and Lynn et al., J. Am. Chem. Soc., 118, 784-790 (1996)). In contrast to anionic and cationic polymerization catalysts, ruthenium metal carbene initiators are tolerant of a wide range of functional groups.

An additional strategy for further modifications is to incorporate selected functional groups at the termini. The attachment of additional functionality at polymer termini further expands the repertoire of uses for materials generated by ROMP. This selective end-capping has been used previously in living titanium and molybdenum-initiated ROMP reactions to synthesize materials for new applications, as demonstrated in the synthesis of surfaces bearing ROMP-derived polymers (Cannizzo et al., Macromolecules, 20, 1488-1490 (1987); Albagli et al., J. Phys. Chem., 97, 10211-10216 (1993); and Albagli et al., J. Am. Chem. Soc., 115, 7328-7334 (1993)). Unlike the titanium and molybdenum initiators, ruthenium ROMP initiators are tolerant of a wide variety of polar functional groups, allowing generation of products not accessible using other catalysts (Grubbs, J.M.S. Pure Appl Chem., A31, 1829-1833 (1994). The attachment of specific end groups to polymers generated by ruthenium carbene-catalyzed ROMP provides access to materials amenable to further functionalization for applications such as selective immobilization of polymers to create new surfaces (Weck et al., J. Am. Chem. Soc., 121, 4088-4089 (1999)) and the development of specific ligands that report on binding events.

As disclosed by U.S. Pat. Nos. 5,312,940 and 5,342,909, vinyl alkylidene catalysts may be synthesized by a variety of methods including the reaction of ruthenium compounds with cyclopropenes or phosphoranes, and neutral or anionic ligand exchange. Of these previous methods, the preferred method of making the catalysts is via the reaction of a substituted cyclopropene with a ruthenium dihalide. Unfortunately, this method is limited to the synthesis of vinyl alkylidene catalysts (i.e., catalysts in which R is hydrogen and R¹ is a substituted vinyl group) and cannot be used to directly synthesize the secondary-alkyl phosphine catalysts. The synthesis of these secondary-alkyl phosphine catalysts further requires reacting the triphenyl phosphine catalysts produced from the cyclopropene reaction with secondary-alkyl phosphines in a ligand exchange reaction.

Also known to those of skill in the art is a method for synthesizing alkylidene complex catalysts via the reaction of substituted diazoalkanes with ruthenium dihalides. The synthetic procedures disclosed in this application can be used to make non-vinyl alkylidene complex catalysts which are more metathesis active than their corresponding vinyl alkylidene counterparts. As in the cyclopropene based methods, the secondary-alkyl phosphine catalysts cannot be synthesized directly from the reaction of ruthenium dihalide and diazoalkanes. Instead, the secondary-alkyl phosphine catalysts must be synthesized by ligand exchange. Although the use of diazo starting materials greatly broadened the range of ruthenium carbene catalysts that could be synthesized, the danger of handling diazo compounds on a large scale severely restricts the commercial and laboratory utility of this method. In addition, the diazo method requires the synthesis to be conducted at low temperature (about −80° C. to −50° C.) and requires the use of considerable amounts of solvent in the final purification of the catalyst. As with the cyclopropene synthesis method, the secondary-alkyl phosphine catalysts must be synthesized using a multi-step ligand exchange procedure which may be time consuming and expensive and may result in lower product yields.

In both the cyclopropene and diazo synthesis methods, the secondary-alkyl phosphine catalysts must be synthesized using a multi-step, ligand exchange procedure. Since the secondary-alkyl phosphine catalysts are more metathesis active than the triphenyl phosphine catalysts and therefore may have wider commercial utility, the necessity of a multi-step synthesis in these cases can be a severe limitation.

Late transition metal catalyzed olefin metathesis is considered a powerful technique for the formation of carbon-carbon bond and has found widespread application in organic synthesis and polymer/material chemistry. Several well-defined Ru-carbene complexes as shown in FIG. 1 are found to be highly actively catalyst precursors with good to excellent stability toward air, moisture and organic functional groups.

As with any other homogeneous catalysts, several drawbacks are associated with these catalysts. They are non-recyclable and destroyed during work-up after a single use. Reactions involving unfavorable substrates often require extremely high catalyst loading. This can limit their industrial application due to economical and operational constraints. Removal of the deeply colored residual Ru complexes often creates serious problems during product purification, which frequently involves extensive chromatographic separation, or post-reaction treatment with special additives such as tris(hydroxymethyl)phosphine and Pb(OAc)₄ which is toxic by itself. Failure to completely remove the Ru residues can cause such complications as double bond migration or undesired side reactions when multi-step synthesis is involved. For the synthesis of biologically relevant molecules and fine chemicals, the problem of residual toxicity may arise. Given the growing importance of olefin metathesis and its tremendous impact on organic synthesis, and in light of the limitations with the existing homogeneous catalysts, easily separable and reusable catalyst for olefin metathesis are highly desirable.

Earlier attempts by Grubbs and Nguyen to prepare polystyrene-supported catalysts based on 1a (FIG. 1) met with only limited success and the resulting polymer-supported Ru carbene complexes were found to be about two orders of magnitude less reactive than the homogeneous analog (FIG. 1). Moreover, recovery and reuse led to small losses in activity (20% after each cycle). No further application of this catalyst has been reported in the literature.

Very recently, Barrett and coworkers have reported on the immobilization of 1b (FIG. 1) on vinyl polystyrene. Unfortunately, attempted recycling and reuse of the immobilized catalyst led to a dramatic decrease in activity. The catalyst survives only a limited number of recyclings and completely loses its activity after the third cycle. Extension of the same methodology to the immobilization of the more reactive catalyst 2b (FIG. 1) also encountered the problem of catalyst decomposition. Therefore, despite the obvious and much desired advantage, development of immobilized Ru carbene complexes as active, truly recyclable, and reusable catalysts for olefin metathesis previously remained a challenging task.

Since facile catalyst separation and subsequent reuse are of prime importance in both industrial and academic settings, a catalyst should ideally be completely recoverable and reusable. In this respect, immobilized or heterogeneous catalysts offer inherent operational and economical advantages over their homogeneous counterparts. It would therefore be useful to develop an immobilized Ru carbene complex which is an active, recyclable, and reusable catalysts for olefin metathesis.

### SUMMARY OF THE INVENTION

According to the present invention, there is provided an immobilized ruthenium complex for use as a catalyst. Also provided is a method of forming a recyclable catalyst for olefin metathesis by attaching a ruthenium carbene to a polymeric support.

### DESCRIPTION OF THE DRAWINGS

Other advantages of the present invention are readily appreciated as the same becomes better understood by reference to the following detailed description when considered in connection with the accompanying drawings wherein:

FIG. 1 is are drawing of several well-defined ruthenium carbene complexes; and

FIG. 2 is a scheme of the monophosphane-based metathesis catalysts of Hoveyda et al., and their regeneration at the end of the reaction.

### DETAILED DESCRIPTION OF THE INVENTION

Generally, the present invention provides a bound ruthenium complex immobilized on a polymer and a method for immobilizing a Ruthenium (Ru) complex for use as a catalyst. More specifically, the present invention provides immobilizing Ru on a soluble polymer. This immobilization enables the Ru complex to be utilized as a recyclable and reusable catalyst without losing any of the catalytic properties of the Ru complex.

In the definitions of “R” groups as used herein, the term “organic group” means a hydrocarbon group (with optional elements other than carbon and hydrogen, such as oxygen, nitrogen, sulfur, phosphorus, germanium, tin, boron, and silicon, which can be in the form of various functional groups) that is classified as an aliphatic group, cyclic group, or combination of aliphatic and cyclic groups (e.g., alkaryl and aralkyl groups). In the context of the present invention, the organic groups are those that do not interfere with the formation of the polymer template or resultant polymer, unless they include the requisite reactive groups.

The term “aliphatic group” means a saturated or unsaturated linear or branched hydrocarbon group. This term is used to encompass alkyl, alkenyl, and alkynyl groups, for example.

The term “alkyl group” means a saturated linear or branched hydrocarbon group including, for example, methyl, ethyl, isopropyl, t-butyl, heptyl, dodecyl, octadecyl, amyl, 2-ethylhexyl, and the like.

The term “alkenyl group” means an unsaturated, linear or branched hydrocarbon group with one or more carbon-carbon double bonds, such as a vinyl group.

The term “alkynyl group” means an unsaturated, linear or branched hydrocarbon group with one or more carbon-carbon triple bonds.

The term “cyclic group” means a closed ring hydrocarbon group that is classified as an alicyclic group, aromatic group, or heterocyclic group (which can be aromatic or aliphatic).

The term “alicyclic group” means a cyclic hydrocarbon group having properties resembling those of aliphatic groups.

The term “aromatic group” or “aryl group” means a mono- or polynuclear aromatic hydrocarbon group.

The term “heterocyclic group” means a closed ring hydrocarbon in which one or more of the atoms in the ring is an element other than carbon (e.g., nitrogen, oxygen, sulfur, etc.).

Substitution is anticipated on the organic groups of the complexes of the present invention. The terms “group” and “moiety” are used to differentiate between chemical species that allow for substitution or that may be substituted and those that do not allow or may not be so substituted. Thus, when the term “group” is used to describe a chemical substituent, the described chemical material includes the unsubstituted group and that group with O, N, Si, or S atoms, for example, in the chain (as in an alkoxy group) as well as carbonyl groups or other conventional substitution. Where the term “moiety” is used to describe a chemical compound or substituent, only an unsubstituted chemical material is intended to be included. For example, the phrase “alkyl group” is intended to include not only pure open chain saturated hydrocarbon alkyl substituents, such as methyl, ethyl, propyl, t-butyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc. On the other hand, the phrase “alkyl moiety” is limited to the inclusion of only pure open chain saturated hydrocarbon alkyl substituents, such as methyl, ethyl, propyl, t-butyl, and the like.

For the structures illustrated herein, each R group can include an organic group, which can be of a significantly large size, for example, on the order of 10,000 carbon atoms, wherein the following applies. Preferably, the organic groups of R¹ and R² are each independently a C₁-C₅₀₀₀ organic group, more preferably, C₁-C₂₅₀₀ organic group, even more preferably C₁-C₁₀₀₀ organic group, and most preferably, C₁-C₁₀₀ organic group, encompassing peptides, proteins, carbohydrates, metal chelators, natural products, etc. Preferably, the organic groups of R⁴, R⁵, R⁶, and R⁷ are each independently a C₁-C_{10,000} organic group, more preferably, C₁-C₆₀₀₀ organic group, even more preferably C₁-C₁₀₀₀ organic group, and most preferably, C₁-C₅₀₀ organic group, encompassing antibodies, nucleic acids, peptides, proteins, carbohydrates, metal chelators, fluorescent tags, enzymes, solid supports, etc. Preferably, the organic group of R³, R⁸, and R⁹ are each independently a C₁-C₂₀ organic group, more preferably, C₁-C₁₀ alkyl group, and most preferably C₁-C₃ alkyl moiety.

Previously, Ru has been immobilized, however, on each occasion the Ru complex has lost some of its catalytic properties thereby lessening the value of the immobilized complex. The present invention provides an immobilized ruthenium complex that does not lose catalytic properties.

The present invention provides a soluble polymer-bound olefin-metathesis catalyst derived from Grubbs' ruthenium carbene complex and poly(ethyleneglycol) (PEG). This PEG-bound catalyst exhibits remarkable chemical stability and can be repeatedly used and recycled in the ring-closing metathesis (RCM) of a variety of a,Φ-dienes, these dienes being known to those of skill in the art.

The method of the present invention involves conventional ROMP methodology or RCM methodology. Briefly, in conventional ROMP polymerization methods, a monomer is used to make a polymer that includes the desired pendant functional groups. Alternatively, the desired pendant functional groups can be attached to preformed polymers that include latent reactive groups.

In the ROMP reaction, a compound according to the present invention is contacted with a cyclic olefin to yield a ROMP polymer product. In the RCM reaction, a compound according to the present invention is contacted with a diene to yield a ring-closed product.

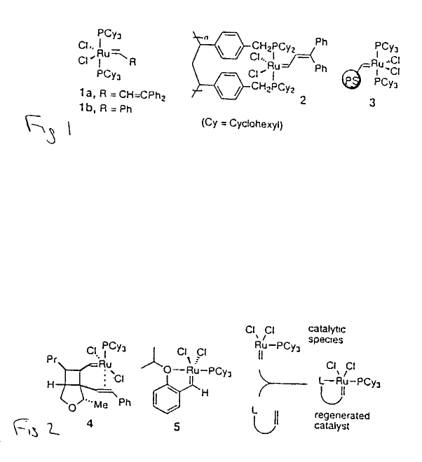

Previously, ruthenium carbenes 4 and 5, (FIG. 2) each bearing one phosphane ligand bound to metal, were found to be remarkably stable and could be isolated and purified by silica-gel column chromatography. Hoveyda and co-workers also demonstrated that 5 (FIG. 2) could be recycled by column chromatography and reused in olefin metathesis. Moreover, these complexes catalyze olefin metathesis with greater propagating rates than 1 (FIG. 1). The bidentate nature of the non-phosphane ligands is particularly attractive in terms of catalyst regeneration since this should be entropically favored. By attaching 5 (FIG. 2) to a polymeric support a recyclable and reusable olefin metathesis catalyst is provided. It is advantageous to use a soluble polymer such a poly(ethylene glycol) as the support since this allows the catalysis reaction to be carried out under standard homogeneous conditions and enables the simple recovery of the catalyst by precipitation and filtration.

Starting from the aldehyde 6 (Scheme 1), the functionalized styrene 8 (Scheme 1) was prepared in straightforward manner. This material was then coupled to poly(ethylene glycol) monomethyl ether (MeO-PEG) derivatized with succinate ester linker 9 (Scheme 1) to give 10 (Scheme 1). The loading of the styrene moiety in 10 (Scheme 1) was estimated by 500 MHz ¹H NMR spectroscopy to be about 0.1 mmol g⁻¹. Following Hoveyda's method for the synthesis of 5 (FIG. 2) from 1b (FIG. 1), the polymer-bound catalyst 11 (Scheme 1) was prepared as a brownish powder by stirring an equimolar mixture of 10 (Scheme 1) and 1b (FIG. 1) in refluxing CH₂CL₂ followed by precipitation with dry diethyl ether.

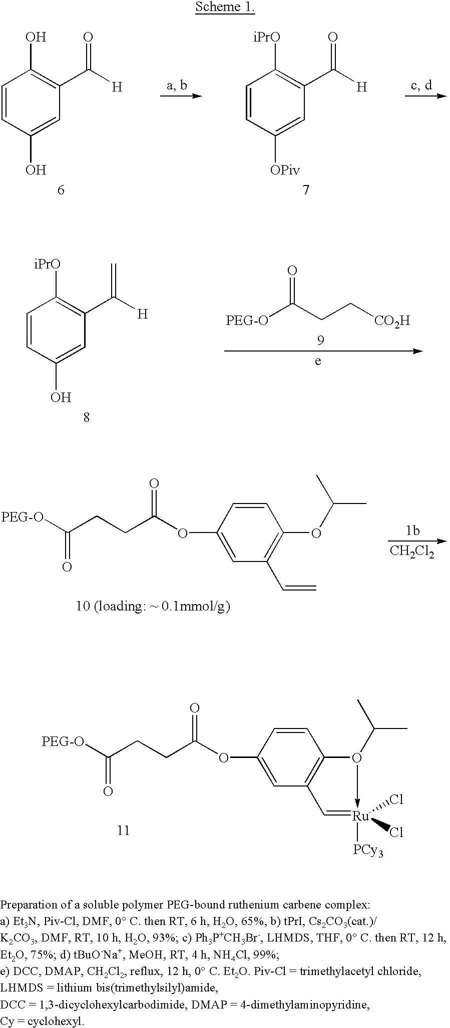

When a solution of the diene 12 (Scheme 2) in CH₂CL₂ was treated with 5 mol % of 11 (Scheme 2) for two hours at reflux, 12 (Scheme 2) was converted cleanly to the cyclic olefin 13 (Scheme 2) in greater than 98% conversion, as determined by 500 MHz ¹H NMR spectroscopy. The catalyst is readily recovered by precipitation with diethyl ether and, as shown in Table 1, the recycled material was used for the next cycle of metathesis, and gave a similarly high conversion. After up to eight runs of recycling and reuse, the catalyst remains active with only very slight loss of activity.

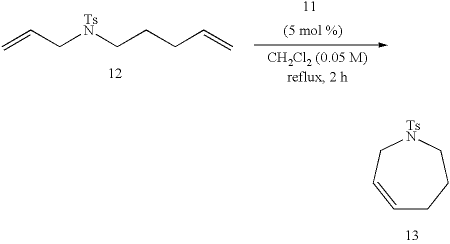

Table 2 lists the results of experiments with other substrates leading to the formation of different carbo- and heterocycles. Ring-closing metathesis of 14 (Table 2) goes cleanly, with high conversion, under conditions similar to those for metathesis of 12 (Scheme 2) (cycles 1-3). Use of a reduced amount (2.5 mol %) of catalyst relative to the substrate in CH₂CL₂ led to high conversion at elevated or room temperatures (cycles 4 and 5, (Scheme 1) respectively). The recycled catalyst from the reaction of 14 (Table 2) was subsequently used for the metathesis of a second substrate 16 (Table 2). The crude product from 16 (Table 2) consists of only the cyclized product 17 (Table 2) and unreacted 16 (Table 2), devoid of any contamination from the previous reaction. It should be noted that sequential use of the same batch of a catalyst in two different reactions is rarely possible, thus being able to do this represents a great practical advantage. The same strategy was applied to the metatheses of 18 and 20 (Table 2).

After the catalyst was used for the reaction of substrate 18 (Table 2), the recycled catalyst was employed to catalyze the metathesis of the silicon-tethered diene 20 (Table 2). With 2.5 mol % of the recycled catalyst, 20 (Table 2) was converted to the cyclic silyl ether 21 (Table 2) in 98% conversion and 94% yield.

While the data presented in Tables 1 and 2 show that the PEG-bound ruthenium carbene complex exhibits remarkable recyclability and can be repeatedly reused in the metathesis of various diene substrates, a slight decrease in catalytic activity is also evident. This is attributable to the slow, but competing, decomposition of the propagating species, a monophosphane-based Ru carbene, [Cy₃PCl₂Ru═CHR] (R═H or Me). A mechanistic study conducted by Grubbs and Ulman has established that decomposition of ruthenium carbene based metathesis catalysts follows a bimolecular pathway involving a monophosphane ruthenium species, formed after dissociation of one phosphane ligand.

In summary, a stable and readily recyclable, soluble, polymer-bound catalyst has been developed for olefin metathesis. In addition to the advantages discussed above, this catalyst can be applied in cases where the limited solubility of a substrate in organic solvents necessitates that the metathesis be carried out in aqueous media, a topic of current interest. The above examples demonstrated that the polymer-bound catalyst 5 (FIG. 2) is a highly active, stable and readily recyclable catalyst for olefin metathesis. In addition to its operational and economic advantages over the existing homogeneous catalysts, most of which are nonrecyclable and destroyed after a single use, catalyst 5 (FIG. 2) can be applied in cases where limited solubility of a substrate in organic solvents necessitates the metathesis to be carried out in aqueous media, which is a topic of considerable academic and industrial interest.

The above discussion provides a factual basis for the use of ruthenium carbene metathesis catalysts. The methods used with a utility of the present invention can be shown by the following non-limiting examples and accompanying figures.

### EXAMPLES

### General Methods

Briefly, in conventional ROMP polymerization methods, a monomer is used to make a polymer that includes the desired pendant functional groups. Alternatively, the desired pendant functional groups can be attached to preformed polymers that include latent reactive groups.

In the ROMP reaction, a compound according to the present invention is contacted with a cyclic olefin to yield a ROMP polymer product. In the RCM reaction, a compound according to the present invention is contacted with a diene to yield a ring-closed product.

In the latter method, a monomer is used that includes in its structure at least one polymerizable group and at least one latent reactive group for subsequent attachment of a pendant functional group (i.e., subsequent functionalization). Thus, suitable latent reactive groups are those that are unreactive during the initial ROMP reaction. Examples of monomer latent reactive groups include activated leaving groups such as an activated ester or protected functional groups such as a protected amine. As used herein, a “protected” group is one in which the intrinsic reactivity of the group is masked temporarily (i.e., the “mask” can be removed).

Latent reactive groups on the monomers that are used for functionalization include electrophilic or nucleophilic groups. Analogously, the compounds from which the pendant functional groups are derived (i.e., the functionalizing reagents) include electrophilic or nucleophilic groups. These two sets of groups can be the same or different, although for any two reactants (monomer and functionalizing reagent) the latent reactive groups are matched to allow for reaction and attachment of the pendant functional group to the polymer template. The resultant polymer acts as a template to which one or more functional groups can be appended using one or more functionalizing reagents that react with the latent reactive groups derived from the monomers (herein referred to as monomer latent reactive groups). These functional groups provide a recognition element (i.e., binding site) for a biological entity, such as a cell surface receptor. Alternatively, they can be generally unreactive (e.g., nonbinding to a cell surface receptor). Thus, the resultant polymers can be bioactive or biocompatible.

Examples of suitable monomers are disclosed, for example, in various documents cited in the Background Section, as well as U.S. Pat. Nos. 5,831,108, 5,342,909, 5,710,298, 5,312,940, 5,750,815, 5,880,231, 5,849,851, 4,883,851, and 5,587,442. Preferred monomers have latent reactive groups and are known to those of skill in the art. Such monomers can be used alone or with prefunctionalized monomers (i.e., those having pendant groups that do not require further functionalization).

Suitable monomers for use in the methods of the present invention that can be used to make a polymer template are those that are stable to the ROMP polymerization conditions. Preferably, suitable monomers are those that can be polymerized through ROMP under standard conditions. More preferably, the monomers include substituted cyclic (e.g., monocyclic, bicyclic, tricyclic, or higher order cyclics) mono-olefins. Examples include, but are not limited to, strained olefins such as norbornene, cyclobutene, and less strained olefins such as cyclooctene. Such substituted cyclic mono-olefins can also include heteroatoms and functional groups within the ring, including, for example, thioethers (RSR′ or R₂ S), ethers (ROR′ or R₂ O), amines (primary RNH2; secondary RR″NH or R₂ NH; tertiary RR′R″N or R₂ R′N or R₃ N), amides (i.e. RCONHR′), and esters (RCO₂ R′). Examples of such olefins include oxanorbornene, 7-thia-bicyclo[2.2.1]hept-2-ene, and 3,6,7,8-tetrahydro-¹H-azocin-2-one.

The monomers can be polymerized to form polymers that are subsequently functionalized at their terminii. The methods of functionalization can include a variety of functionality such as: (1) monomer latent reactive groups that can be functionalized to include pendant functional groups after polymerization; (2) nonreactive functionality that does not require further functionalization to produce the desired pendant functional groups (which can be simple or complex); or (3) no pendant functional groups (as in norbornene). Various combinations of such monomers can be used in the methods of the present invention to provide block or random copolymers.

In either ROMP reaction (conventional or alternatives), varying the ratio of monomer to ROMP catalyst (i.e., initiator) results in varying the length of the resultant polymer. The polymer (or polymer template) is preferably prepared by polymerizing one or more monomers using a metal carbene catalyst (i.e., a compound containing a metal carbene (M═CR⁴ R⁵) bond that catalyzes metathesis reactions, wherein the R groups are each independently H or an organic group (which can include functionality, such as the latent reactive groups or nonreactive functional groups described below), and “M” represents a metal (preferably, ruthenium) bonded to one or more ligands in a ligand sphere). Specific examples of suitable catalysts include, but are not limited to, Grubb's ruthenium metal carbene catalyst and the compounds disclosed in Kingsbury et al., J. Amer. Chem. Soc., 121, 791-799 (1999); Schwab et al., J. Amer. Chem. Soc., 118, 100-110 (1996); Dias et al., Organometallics, 17, 2758-2767 (1998); del Rio et al., Tetrahedron Lett., 40, 1401-1404 (1999); Furstner et al., Chem. Commun., 95-96 (1999); Weskamp et al., Angew. Chem., Int. Ed. Engl., 37, 2490-2493 (1998); and Scholl et al., Tetrahedron Lett., 40, 2247-2250 (1999). Others include those disclosed in, for example, U.S. Pat. No. 5,831,108 (Grubbs et al.), U.S. Pat. No. 5,342,909 (Grubbs et al.), U.S. Pat. No. 5,710,298 (Grubbs et al.), U.S. Pat. No. 5,312,940 (Grubbs et al.), U.S. Pat. No. 5,750,815 (Grubbs et al.), U.S. Pat. No. 5,880,231 (Grubbs et al.), U.S. Pat. No. 5,849,851 (Grubbs et al.), and U.S. Pat. No. 4,883,851 (Grubbs et al.).

A preferred group of catalysts include those that react with electron rich alkenes and preferably have at least one latent reactive group (referred to herein as a catalyst latent reactive group) and/or at least one desired nonreactive functional group. Nonreactive functional groups include, for example, natural products or analogs thereof, metal chelators, metals, fluorescent probes, solid supports, and metal surfaces.

Latent reactive groups on the catalyst are analogous to the latent reactive groups on preferred monomers in that these reactive groups do not interfere with the ROMP reaction, but allow for subsequent functionalization.

The catalyst latent reactive groups that are used for functionalization include electrophilic or nucleophilic groups. Examples of electrophilic latent reactive groups include, but are not limited to, acyl sulfonamides, acyl azides, epoxides, anhydrides, esters (including activated esters such as pentafluorophenyl esters and N-hydroxysuccinimidyl esters), carboxylic acids (including activated acids such as acyl halides), halides, boronic acids, ketones, aldehydes, phosphoric acid esters (mono-, di-, and ti-esters), phosphites, acyl nitrites, alkenes, and alkynes, and the like. Examples of nucleophilic latent reactive groups include, but are not limited to, amines, azides, hydroxyls, thiols, sulfones, acyl hydrazides, phosphites, hydrazines, oximes, isocyanates, thiocyanates, and the like. The stereochemistry of these groups can be defined or racemic. If desired these groups can be protected with groups such as carbamates, carbonates, thioethers, disulfides, nitro groups, and the like. Preferably, in the formula M═CR⁴ R⁵, wherein M represents a metal in a ligand sphere), R⁴ is an organic group that includes a latent reactive group, such as an azide, an epoxide, a cyano group, an acetal, a ketal, a carbonate, a thiocyanate, an activated ester, an activated acid, a hydrazine, or a hydrazone, and R⁵ is H or an organic group, preferably, H.

The catalysts can be used to incorporate functionality at a terminus of the polymer to allow, for example, for coupling of two polymers together, coupling of the polymer to a solid support, or modification with small molecules, fluorescent probes, proteins, metals, metal chelators, etc. Thus, catalysts useful in the methods of the present invention can include a variety of functionality (in at least one of R⁴ or R⁵ in the catalyst M═CR⁴ R⁵) such as: (1) catalyst latent reactive groups that can be functionalized to include terminal functional groups after polymerization; (2) nonreactive functionality that does not require further functionalization to produce the desired terminal functional groups; or (3) no functional groups. Various combinations of such catalysts can be used in the methods of the present invention.

The initial polymerization is preferably carried out in a solvent or mixture of solvents, typically one or more organic solvents, in which the monomer and catalyst are mutually soluble, although in certain embodiments, no solvent is required. Suitable solvents include substituted and unsubstituted aliphatic and aromatic hydrocarbon solvents such as chlorinated hydrocarbons, ethers, protic hydrocarbons, etc., which are unreactive under the reaction conditions. Examples include 1,2-dichloroethane, benzene, toluene, p-xylene, methylene chloride, dichlorobenzene, tetrahydrofuran, diethylether, pentane, water, methanol, etc.

The conditions of the polymerization reaction (e.g., temperature, time, atmosphere) vary depending on the choice of monomer and catalyst, and can be selected by one of skill in the art without undue experimentation. Preferably, the ROMP reaction is carried out at a temperature of about 20 [symbol] C. to about 30 [symbol] C. (i.e., room temperature) or higher under an inert atmosphere (e.g., nitrogen or argon), although temperatures ranging from about −20 [symbol] C. to about 125 [symbol] C. are possible. Pressure is not critical, but can be varied to maintain a liquid phase reaction mixture. Reaction times can vary from several minutes to several days.

Typically, in ROMP reactions, the polymer is terminated by reacting the catalyst with a capping agent. This capping agent is typically matched to the catalyst. For ruthenium catalysts, for example, ethyl vinyl ether has been used. Although such a reagent could be used in the present invention, preferably, an electron rich alkene is used to incorporate terminal functionality in the polymer. As used herein, an electron rich alkene is one that has greater electron density than that of ethylene. In conventional capping methods, the capping agent is a vinyl ether, typically ethyl vinyl ether, that yields a material with a terminal alkene and a deactivated alpha-oxygen-substituted ruthenium metal carbene (Hillmyer, Macromolecules, 28, 6311-6316 (1995)).

Alternatively the capping agent can be a bifunctional capping agent, which incorporates an electron donating group, and preferably either a latent reactive group for subsequent functionalization (e.g., to incorporate functionality at a terminus of the polymer to allow for coupling of two polymers together, coupling to a solid support, or modification with small molecules, fluorescent probes, proteins, metals, metal chelators, etc.) or a nonreactive functional group that does not require further functionalization (i.e., it is the functionality that is desired to be incorporated into the polymer at a terminus, such as reporter groups to facilitate detection such as fluorescent groups, chemiluminescent groups, enzymes, antibodies, biotin, radioactive groups, etc.). Thus, in a similar manner to that of the catalyst, capping agents useful in the methods of the present invention can include a variety of functionality (in at least one of R⁶ or R⁷ in the capping agent D-C CR⁶ R⁷) such as: (1) capping agent latent reactive groups that can be functionalized to include terminal functional groups after polymerization; (2) nonreactive functionality that does not require further functionalization to produce the desired terminal functional groups; or (3) no functional groups (as in ethyl vinyl ether). Various combinations of such capping agents can be used in the methods of the present invention.

Significantly, the catalysts and capping agents of the present invention are of general utility for controlling the structure of the terminii of living ruthenium-initiated ROMP reactions. Selective incorporation of single end groups into polymers facilitate the creation of bifunctional polymers that can be appended to other oligomers, selectively immobilized, used for detection, used for quantitative binding studies, or to investigate polymer structure. The resulting materials can be conjugated to any of a number of reporter molecules, including a variety of fluorescent compounds, biotin, antibodies, enzymes, lipids, and solid supports. The functional group tolerance of the metal carbene initiator, the flexibility in catalyst selection, the generality of the post-synthetic functionalization protocol, and the versatility of the capping strategy expands significantly the scope of useful materials that can be generated by ROMP.

### Example 1

Ring-Closing Metathesis of Diene 10 (Scheme 1) to produce cyclic olefin 11 (Scheme 1) and General Procedure for Catalyst Preparation and Recycling:

A 5 mL flask equipped with a micro reflux condenser was charged with styrene 9 (Scheme 2) (100 mg, ˜0.01 mmol) and Cl₂Ru(═CHPh)(PCY₃)₂ (8.2 mg, 0.01 mmol), evacuated and filled with dry Ar. Anhydrous CH₂Cl₂ (0.5 mL) was then added and the resultant mixture was heated to reflux (bath temperature 50-55° C.). After 12 hours, the reaction mixture was cooled to room temperature and transferred to a 15 mL flask. Anhydrous ether (10 mL) was then added dropwise with stirring. The precipitate was filtered, washed thoroughly with cold ether (3×2 mL) and dried in vacuo to give 5 (FIG. 2) (104 mg) as a light brown powder. The catalyst was placed in a 25 mL flask equipped with a reflux condenser. The flask was evacuated and filled with Ar. Diene 10 (Scheme 1) (56 mg, 0.20 mmol) was introduced in dry CH₂Cl₂ (4mL, 0.05 M) with a syringe. After heating to reflux (bath temperature 50-55° C.) for two hours, the reaction mixture was cooled to room temperature and concentrated to about 0.5 mL. Ice cold anhydrous ether (10 mL) was added dropwise with stirring. The precipitate was filtered, washed with cold ether (3×2 mL), dried, and collected to give the recycled catalyst (104 mg). The filtrate and washings were combined and evaporated. Examination of the crude reaction mixture by ¹H NMR revealed clean formation of the cyclized product 11 (Scheme 1) together with unreacted 10 (Scheme 1) in the ratio 98:2.

A second run of the metathesis of 10 (Scheme 1) using the recycled catalyst was conducted in exactly the same way as described for the first cycle, resulting in the formation of a crude reaction mixture with the ratio 13:12=97.5:2.5. This reaction was repeated six more times, each using the catalyst recycled from a previous cycle. The results are listed in Table 1 of the text.

### Example 2

A sample of catalyst 5 (FIG. 2) was prepared from 10 (Scheme 1) (100 mg, 0.01 mmol) and Cl₂Ru(═CHPh)(PCy₃)₂ (8.2 mg, 0.01 mmol) according to the general procedure described above and used in the ring-closure metathesis of diene 16 (Table 2) (81 mg, 0.4 mmol) in CH₂Cl₂(4 mL, 0.1 M) at reflux for 2 hours. The catalyst was recycled by the general procedure. Examination of the crude reaction mixture by 500 MHz ¹H NMR revealed clean formation of 17 (Table 2) together with unreacted 19 (Table 2) in the ratio 96:4. The recycled catalyst was used in the ring-closure metathesis of diene 18 (Table 2) (104 mg, 0.4 mmol) in CH₂Cl₂ (4 mL, 0.1 M) at reflux for 3 h. The catalyst was recovered according to the general procedure. ¹H NMR revealed clean formation of 19 (Table 2) in >98% conversion. Purification by flash column chromatography on silica (Pentane/CH₂Cl₂ 4:1 to 3:1) gave 19 (Table 2) (87 mg, 93.7%) as a colorless oil. 1H NMR (CDCl₃, 500 MHz): δ7.31-7.20 (m, 5H), 5.84 (dt, ¹H, J=10.3, 8.1 Hz), 5.50 (ddt, ¹H, J=2.1, 6.0, 10.7 Hz), 4.84 (dd, ¹H, J=4.1, 10.6 Hz), 2.61 (dq, ¹H, J=5.6, 11.7 Hz), 2.08-2.05 (m, ¹H), 1.94 (bdd, ¹H, J=7.3, 13.8 Hz), 1.88-1.78 (m, ²H), 1.35 (dd, ¹H, J=8.6, 13.8 Hz), 0.21 (s, ³H), 0.09 (s, ³H). 13C NMR (CDCl₃, 125 MHz) δ145.8, 128.1, 127.0, 126.9, 126.6, 125.2, 72.0, 38.8, 23.7, 19.4, −0.7, −3.2. Analysis Calculated for C₁₄H₂₀OSi: C, 72.36; H, 8.67. Found: C, 72.20; H, 8.91.

The present invention therefore provides a soluble polymer-bound olefin metathesis catalyst. The catalyst was made via ligand exchange of the Grubbs ruthenium benzylidene with a styrene molecule attached to poly(ethylene glycol) monomethyl ether. The polymer-bound Ru carbene exhibits remarkable stability and catalyzes the ring-closing metathesis of a variety of a, Φ-dienes leading to the formation of 5, 6, 7 and 8-membered carbo- and heterocycles at either room or elevated temperatures. The catalyst can be completely recovered simply and 8-membered carbo- and heterocycles at either room or elevated temperatures. The catalyst can be completely recovered simply by precipitation with ether in the air and repeatedly reused (up to eight runs) without appreciable loss of activity.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

TABLE 1
Recycling and reuse of polymer-bound Ru complex 11
in the ring-closing metathesis of diene 12.

| Cycle | 1 | 2 | 3 | 4 | 5 | 6 | 7 | 8 |
|---|---|---|---|---|---|---|---|---|
| conversion [%] | 98 | 97.5 | 96.5 | 95 | 95 | 93 | 93 | 92 |

TABLE 2
Ring-closing metathesis catalyzed by polymer-bound Ru
complex 11 in CH₂Cl₂.

| | Substrate | | Catalyst | | Conversion |
|---|---|---|---|---|---|
| Cycle | [conc] | Product | [mol %] | Conditions | [%] |
| | 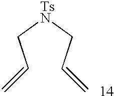 | 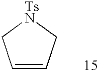 | | | |
| 1 | (0.05 M) | | 5 | reflux. 2 h | 96 |
| 2 | (0.05 M) | | 5 | reflux. 2 h | 94 |
| 3 | (0.05 M) | | 5 | reflux. 2 h | 92 |
| 4 | (0.1 M) | | 2.5 | reflux. 3.5 h | 96.5 |
| 5 | (0.1 M) | | 2.5 | RT. 12 h | >99 |
| | 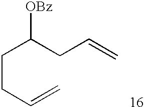 | 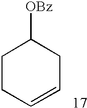 | | | |
| 6 | (0.1 M) | | 2.5 | reflux. 2 h | 90 |
| | 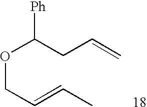 | 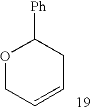 | | | |
| 1 | (0.1 M) | | 2.5 | reflux. 2 h | 96 |
| | 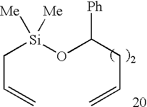 | 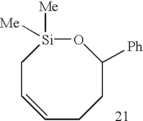 | | | |
| 2 | (0.1 M) | | 2.5 | reflux. 3 h | >98 |

### References

U.S. Pat. Nos.

4,883,851

5,312,940

5,312,940

5,342,909

5,342,909

5,587,442

5,710,298

5,750,815

5,831,108

5,849,851

5,880,231

6,111,121

Publications

Ahmed, M., et al. Synlett 2000, 1007-1009

Ahmed, M., et al. Tetrahedron Lett. 1999, 40, 8657-8662

Albagli et al., J. Am. Chem. Soc., 115, 7328-7334 (1993)

Albagli et al., J. Phys. Chem., 97, 10211-10216 (1993)

Biagini et al., Chem. Commun., 1097-1098 (1997)

Biagini et al., Polymer, 39, 1007-1014 (1998)

Cannizzo et al., Macromolecules, 20, 1488-1490 (1987)

del Rio et al., Tetrahedron Lett., 40, 1401-1404 (1999)

Dias et al., J. Am. Chem. Soc., 119, 3887-3897 (1997)

Dias et al., Organometallics, 17, 2758-2767 (1998)

Furstner et al., Chem. Commun., 95-96 (1999)

Gibson et al., Chem. Commun., 1095-1096 (1997)

Gordon et al., Nature, 392, 30-31 (1998)

Grubbs, J. M. S. Pure Appl Chem., A31, 1829-1833 (1994)

Hillmyer, Macromolecules, 28, 6311-6316 (1995)

Ivin, Olefin Metathesis and metathesis polymerization; Academic Press: San Diego, 1997

Kanai et al., J. Am. Chem. Soc., 119, 9931-9932 (1997)

Kiessling et al., Topics in Organometallic Chemistry, 1, 199-231 (1998)

Kingsbury et al., J. Am. Chem. Soc., 121, 791-799 (1999)

Lynn et al., J. Am. Chem. Soc., 118, 784-790 (1996)

Mortell et al., J. Am. Chem. Soc., 116, 12053-12054 (1994)

Mortell et al., J. Am. Chem. Soc., 118, 2297-2298 (1996)

Nguyen, S. T., et al. J. Organomet. Chem. 1995, 497, 195-200

Sanders et al., J. Biol. Chem., 274, 5271-5278 (1999)

Scholl et al., Tetrahedron Lett., 40, 2247-2250 (1999)

Schrock et al., J. Am. Chem. Soc., 112, 3875-3886 (1990)

Schwab et al., J. Amer. Chem. Soc., 118, 100-110 (1996)

Schwab, P., et al. “Synthesis and Applications of RuCl2(═CHR′)(RP3)2: The Influence of the Alkylidene Moiety on Metathesis Activity” J. Am. Chem. Soc. 1996, 118,100-110

Weck et al., J. Am. Chem. Soc., 121, 4088-4089 (1999)

Weskamp et al., Angew. Chem., Int. Ed. Engl., 37, 2490-2493 (1998)

Yao, Q. Angew. Chem. Int. Ed. Engl. 2000, 112, 4060-4062

Yao, Q. Angew. Chem. Int. Ed. Engl. 2000, 39, 3896-3898

What is claimed is:

1. An immobilized ruthenium complex for use as a catalyst, wherein said complex is immobilized on a polymer.

2. The complex according to claim 1, wherein said complex is a catalyst for olefin metathesis derived from Grubbs' ruthenium carbene complex and PEG.

3. The complex according to claim 1, wherein said complex is a recyclable and reusable olefin metathesis catalyst.

4. The complex according to claim 5, wherein said complex is recycled in the ring closing metathesis of dienes.

5. The complex according to claim 1, wherein said complex is immobilized on a soluble polymer.

6. The complex according to claim 5, wherein said soluble polymer is poly(ethylene glycol).

7. The complex according to claim 1, wherein said complex can be used in aqueous media.

8. A method of forming a recyclable catalyst for olefin metathesis by attaching a ruthenium carbene to a polymeric support.

9. The method according to claim 8, wherein said attaching step includes binding the ruthenium carbene using PEG.
